(19) United States
(12) Patent Application Publication
(10) Pub. No.: US 2018/0263739 A1
(43) Pub. Date: Sep. 20, 2018

(54) DENTAL MODELING SYSTEM AND METHOD WITH DIRECT IMPLANT ANALOG AND THREAD RETENTION

(71) Applicant: EVOLLUTION IP HOLDINGS, INC., Birmingham, AL (US)

(72) Inventors: Boris A. SIMMONDS, Vestavia, AL (US); Fred J. MOLZ, IV, Birmingham, AL (US)

(73) Assignee: EVOLLUTION IP HOLDINGS, INC., Birmingham, AL (US)

(21) Appl. No.: 15/921,802

(22) Filed: Mar. 15, 2018

Related U.S. Application Data
(60) Provisional application No. 62/472,071, filed on Mar. 16, 2017.

(51) Int. Cl. A61C 13/00; A61C 8/00; A61C 9/00

(52) U.S. Cl. CPC A61C 13/0004; A61C 8/0089; B33Y 80/00; A61C 8/0001; A61C 9/0053

(57) ABSTRACT

A dental model including an implant analog and surrounding modeled dentition is disclosed, and also systems and methods for application of such a dental model in implant dentistry. The implant analog models an actual dental implant in the mouth of a patient and the modeled surrounding dentition models actual dentition surrounding the actual dental implant in the mouth of the patient. In example forms, the implant analog and modeled dentition comprise an integrally formed monolithic body generated from a digital intra-oral scan of the patient.

### CROSS-REFERENCE TO RELATED APPLICATION

This application claims the benefit of U.S. Provisional Patent Application Ser. No. 62/472,071 filed Mar. 16, 2017, the entirety of which is hereby incorporated herein by reference for all purposes.

### TECHNICAL FIELD

The present invention relates generally to the field of restorative implant dentistry, and more particularly to apparatus, systems and methods of production and use of a dental model including one or more integral dental implant analogs, and further to enhanced thread engagement and retention within a dental implant analog.

### BACKGROUND

Dental implants are commonly used in restorative dentistry to affix a dental prosthesis to the jaw of a human or animal patient. Typically, a dental practitioner installs an externally threaded implant into an aperture formed in the bone of the patient's jaw, to which an artificial tooth, crown, or other dental prosthesis will be attached. After placement of the implant, the surrounding bone tissue is allowed to heal and an abutment mount upon which the dental prosthesis is fabricated is secured to the implant. Typically, an abutment screw is used to attach the prosthesis to the implant via an anchoring bore through the abutment and into an internally threaded bore in the implant. Optionally, a temporary crown or healing abutment may be attached to the implant during healing and fabrication of a permanent prosthesis.

A physical model of the patient's intraoral cavity may be utilized to facilitate design and manufacture of the dental prosthesis to be mounted to the implant. Traditionally, the model was produced by impression molding using a dental impression tray and impression material to cast a replica of the patient's intraoral structure (an “analog” process of producing a model). More recently, models have been made using an electronic intraoral scanner to generate a digital model, from which a physical model can be created by 3D printing, CNC milling, or other computer aided manufacture technique (a “digital” process of producing a model). The models or casts are typically formed from dental plaster or gypsum stone, acrylic, or polymeric resins, and may be of a full or partial dental arch of one or both of the patient's upper and lower jaw dentition.

The location and orientation of a dental implant that has been placed in the patient's jaw is transferred to the physical dental model by use of an impression coping engaged in the implant (using an analog modeling process), or by a scan body engaged in the implant (using a digital modeling process). Traditionally, an implant replica or analog of the actual implant is then placed into the physical model in the indicated location and orientation. The practitioner (or a lab technician at the direction of the practitioner) then uses the physical model with the implant analog placed therein to design and manufacture an abutment and crown prosthesis configured to be engaged with the implant and fit the patient's surrounding dentition and bite. Once the prosthesis has been fit and tested on the model and its implant analog, the practitioner will fit, adjust and install the prosthesis to the actual implant within the patient's mouth.

Precise and accurate placement of the implant analog within the dental model can be difficult, however, due to a variety of reasons, including manufacturing tolerances, and/or errors or inconsistencies at any stage of the process. Inaccuracies in placement of the implant analog within the dental model can result in improper fit of the prosthesis to the patient, and/or additional “chair time” for the patient while the dental practitioner adjusts and fits the prosthesis. Also, for unitary models, the materials from which the physical dental model and/or the implant analog are constructed may lack sufficient thread-holding strength to withstand more than light engagement of the abutment screw when mounting the abutment and prosthesis to the implant analog when fitting and adjusting the prosthesis to the model during manufacture. Over-tightening of the abutment screw may strip threads or otherwise damage the model or the implant analog, detach the implant analog from the model, or improperly alter the position of the implant analog within the model; whereas under-tightening may position the prosthesis differently on the model than when installed in the patient's mouth, resulting in a less accurate and precise fit.

Accordingly, it can be seen that needs exist for improved apparatus, systems and methods of production and use of a dental model including one or more dental implant analogs, and further to enhanced thread engagement and retention with a dental implant analog and dental model. It is to the provision of improved apparatus, systems and methods meeting these and other needs that the present invention is primarily directed.

### SUMMARY

In example embodiments, the present invention provides improved apparatus, systems and methods of production and use of a dental model including one or more dental implant analogs (an analog or model of an actual dental implant), and further to enhanced thread engagement and retention with a dental implant analog and dental model. In example forms, the invention provides a physical dental model having an integral implant analog directly formed as a unitary and monolithic part of the model, and corresponding directly or in a functionally analogous manner to the position and geometry of the actual dental implant that has been placed in the patient. In this manner, tolerances between parts and/or inaccuracies in installation of a separate implant analog into a dental model are substantially reduced or eliminated, resulting in more precise modeling, manufacture and fit of a dental prosthesis. In further example forms, a thread-retention portion or body formed of metal or other high-strength material is embedded in the physical dental model in alignment with the implant analog, to allow tighter engagement of the abutment screw to more closely match actual placement conditions of the prosthesis into the patient's mouth, and eliminate or substantially reduce stripping threads or otherwise damaging the model and/or implant analog during manufacture and fitting of the prosthesis using the model.

In one aspect, the present invention relates to a dental model. The dental model preferably includes an implant analog and modeled dentition surrounding the implant analog. The implant analog models an actual dental implant in the mouth of a patient and the modeled dentition models actual dentition surrounding the actual dental implant in the mouth of the patient. The implant analog and modeled dentition preferably comprise an integrally formed monolithic body.

In another aspect, the invention relates to a system for dental modeling and delivery of a dental prosthesis to a patient. The system preferably includes a dental implant for implantation in the mouth of the patient, a dental prosthesis comprising an abutment mount configured for cooperative engagement with the dental implant, and an abutment screw configured for engagement through the abutment mount and into engagement with the dental implant to retain the dental prosthesis in place on the dental implant. The system preferably also includes a dental model comprising an implant analog and modeled dentition surrounding the implant analog. The implant analog models the dental implant and the modeled dentition models actual dentition in the mouth of the patient. The implant analog and modeled dentition preferably comprise an integrally formed monolithic body.

In still another aspect, the invention relates to a method of dental modeling for installation of a dental prosthesis in a patient's mouth. The method preferably includes the steps of providing a dental implant for placement at an implant site in the patient's mouth adjacent to surrounding dentition; generating a digital dental model by scanning the implant site and the surrounding dentition, wherein the digital model comprises data corresponding to at least one characteristic of the dental implant; fabricating a physical dental model based on the digital dental model, the physical dental model comprising at least one implant analog modeling the dental implant and modeled dentition modeling the surrounding dentition, wherein the implant analog and modeled dentition comprise an integrally formed monolithic body; preparing a dental prosthesis using the physical dental model; and affixing the dental prosthesis to the dental implant in the patient's mouth.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a dental model including integral dental implant analogs according to an example embodiment of the present invention.

FIG. 2A is an assembly view in partial cross-section showing an abutment mount and abutment screw of a dental prosthesis arranged for attachment to a dental implant analog portion of the dental model of FIG. 1.

FIG. 2B shows the abutment mount of FIG. 2A affixed to the implant analog of the dental model, with the abutment screw engaged through the abutment and into engagement with a thread-retention body portion of the implant analog.

FIG. 3 is a perspective view of the abutment mount of FIGS. 2A and 2B affixed to the implant analog of the dental model.

FIG. 4 shows a dental prosthesis mounted to a dental implant analog portion of a dental model according to an alternative embodiment of the present invention.

FIG. 5 shows a dental implant analog according to an alternative embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

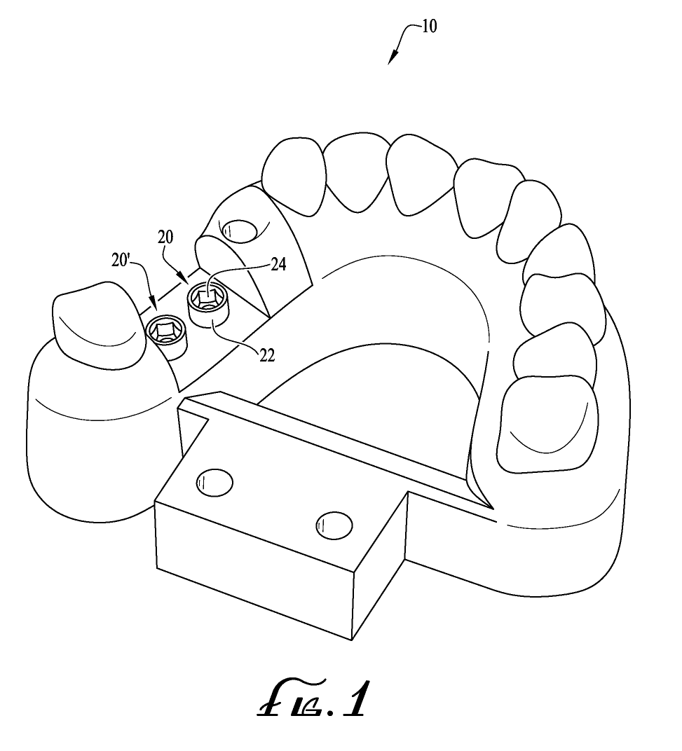

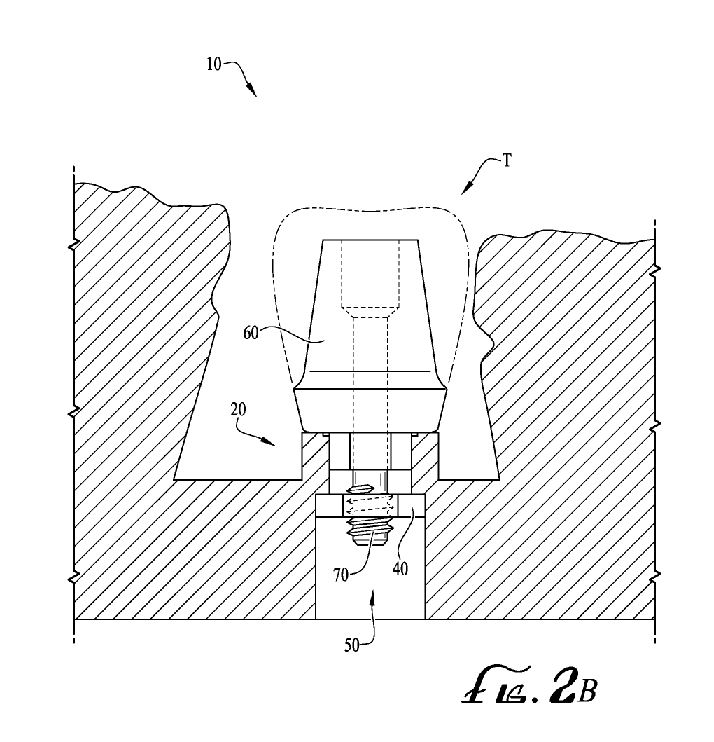

With reference now to the drawing figures, wherein like reference numbers represent corresponding parts throughout the several views, FIG. 1 shows a dental model 10 having two dental implant analogs 20, 20′ directly and integrally formed with the model as an integral monolithic structure. The model 10 comprises an accurate representation of the structure of at least a portion of a patient's intraoral dentition, typically including one or more teeth, gum tissue and/or jaw structure surrounding the placement of one or more dental implants, and further comprises a base or support structure for the modeled dentition. In the depicted embodiment, the model 10 is a full-arch single-jaw model of a human patient's dentition including modeled representation of a full set of upper or lower teeth, gums and implants, but in alternate embodiments may comprise a partial-arch or other dental model format. In the depicted embodiments (with particular reference to FIGS. 1 and 3), a portion of the modeled dentition 10 representing soft tissue (gums) immediately surrounding the implant analog(s) 20 is cut-out or omitted from the model for improved access to the implant analog(s). The model 10 can optionally comprise one or more removable and replaceable portions or segments representing the omitted soft tissue for placement over the implant analog(s) in the cut-out areas, or alternatively can include modeled soft tissue surrounding the implant analog(s) as an integral portion of the model.

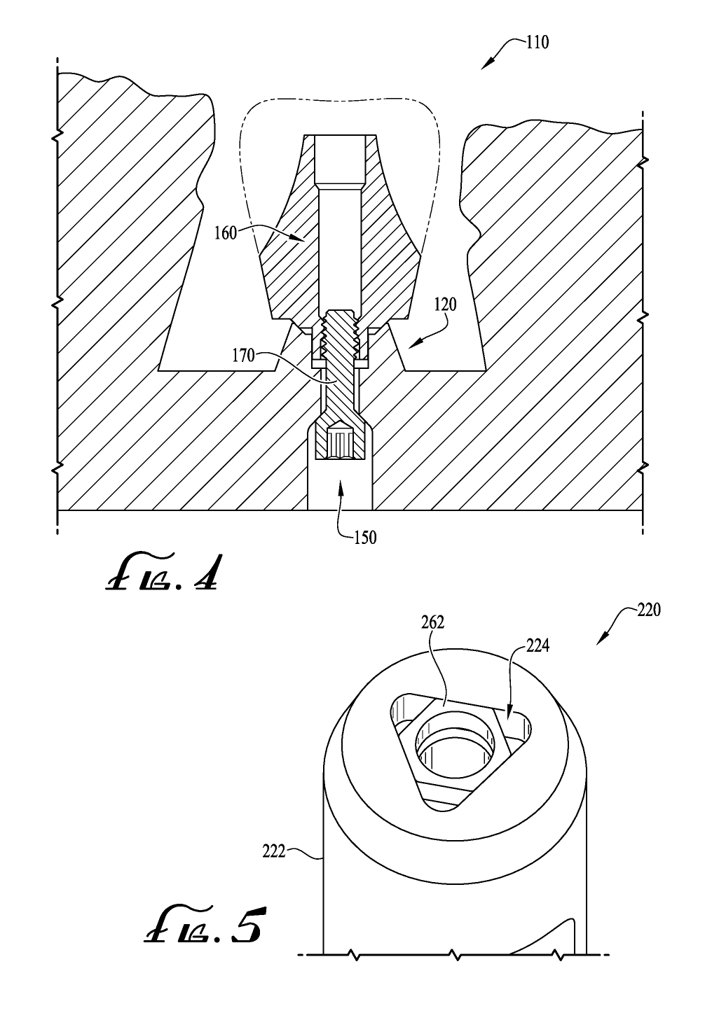

The implant analog 20 of the model 10 comprises a generally cylindrical external geometry 22, and an internal hexagonal recess 24 extending from the top of the analog down through the material of the model and into communication with a lower recess 26 formed into the bottom surface of the model. The top rim of the implant analog defines a generally flat annular abutment contact surface 28, optionally having a small recessed relief portion surrounding the hexagonal recess. In alternate embodiments, the internal recess of the implant analog may be functionally analogous to a hexagonal recess, but defining a square, triangular, or other polygonal or otherwise shaped female recess configuration compatible with a hexagonal or otherwise configured male engagement profile of a corresponding dental prosthesis abutment mount, as described in greater detail below with reference to FIG. 5. In still further alternate embodiments, the implant analog may comprise a male (hexagonal or otherwise configured) engagement profile for compatible engagement with a corresponding female engagement profile of a dental prosthesis abutment mount.

In example embodiments, the dental model 10 is produced using a digital modeling process wherein a dental practitioner uses an intraoral optical or computed tomography (CT) scanner to create a three-dimensional digital model of the patient's dentition, including the location, configuration, and orientation of one or more dental implants placed in the patient's jaw, and surrounding teeth and gum tissue. Optionally, a digital scan body may be temporarily installed in the implant in the patient's mouth during the scan to facilitate precise capture of the location and orientation of the implant relative to the patient's surrounding dentition in the three-dimensional digital model. In alternate embodiments, the dental model 10 may be produced using an analog modeling process, for example using impression material within an impression tray, pressed over the patient's dentition, and cured and removed to form a mold. In example embodiments, the internal geometry of the actual physical dental implant in the patient's mouth, including the hexagonal recess for engagement of a dental prosthesis abutment mount, is directly reproduced in the digital model by importing or building a set of digital files corresponding to one or more dental implant geometries into a dental design software system (such as for example the 3Shape Dental System of 3Shape A/S of Copenhagen Denmark).

The physical dental model 10 may then be fabricated from the three-dimensional digital model generated by the scan, for example by 3D printing, CNC milling, or other computer aided manufacturing (CAM) digital fabrication process. Alternatively, in an analog fabrication process, the impression mold may be used to cast the physical model from dental modeling plaster, gypsum stone or resin. The dental implant analog 20 is a modeled representation of an actual dental implant that has been implanted in the patient's mouth, and the model 10 further comprises one or more modeled teeth, gum tissue, and/or other modeled features accurately representing the size, shape, location and orientation of corresponding actual features in the patient's mouth. The implant analog 20 is preferably fabricated as a unitary integral part of the model 10 in a monolithic body, for example by a continuous 3D printing process, or by milling the model including the implant analog(s) from a single workpiece of material. By directly forming the physical dental model 10 (including the implant analog portion 20 and its internal geometry) as a monolithic body from the digital model generated from the scan of the patient's dentition, positional inaccuracies and tolerance stacking resulting from the modeling process and/or from installation of a separate implant analog into a previously formed physical dental model are substantially reduced or eliminated, resulting in a physical model that more accurately represents the actual physiology of the patient's mouth.

In further embodiments, the physical dental model 10 optionally further comprises a thread-retention portion or body on or within the model, and positioned in operative alignment with the implant analog 20, to resist or prevent stripping of threads in the physical model during manufacture and test-fitting of a dental prosthesis using the model. In example embodiments, the thread-retention portion comprises an insert of metal, ceramic, high-strength polymer or other thread-retention material having a greater thread-holding capacity than the base material from which the implant analog and surrounding dentition portions of the physical dental model are formed, and preferably having sufficient hardness and toughness to engage and retain a threaded connection at typical insertion forces and torques used in attachment of a dental prosthesis to a dental implant in standard implant dentistry. For example, in the depicted embodiment the thread-retention insert comprises a steel nut 40 having a hexagonal exterior profile and an internally threaded bore extending therethrough. The nut 40 is inserted into a correspondingly configured hexagonal recess 50 formed in the underside of the model 10, opposite the implant analog portion 20. The threaded internal bore of the nut 40, when the nut is positioned within the lower recess 50, is coaxially aligned with the hexagonal recess 24 of the implant analog 20, and the lower recess 50 extends through the model into communication with the internal recess 24 of the implant analog. In example embodiments, the recess 50 is sized to receive the nut 40 with a close sliding, interference or press fit, to hold the nut in place upon insertion. Alternatively, the nut 40 can be held in place by adhesive, mechanical couplings or other attachment means. In alternate embodiments, the thread-retention portion or body may comprise a threaded insert of differing geometry, an embedded body of thread-retaining material co-molded or co-printed with the model 10, or be otherwise inserted, embedded or formed within the model, as a separately attached component or integrally formed as part of the model.

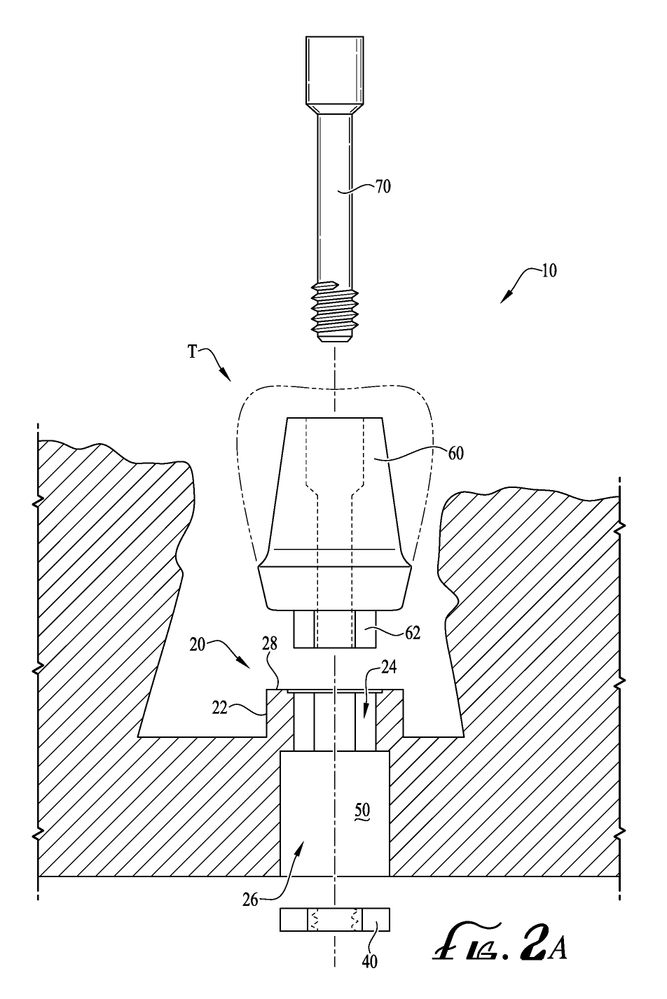

In example modes of use, a dental practitioner, lab technician or other user of the physical dental model 10 may fabricate and test fit a dental prosthesis using the model, in order to minimize chair-time and discomfort to the patient that might otherwise be necessary if the prosthesis were produced and fitted directly into the patient's mouth without use of a model. For example, a prosthetic tooth T (shown in broken lines in FIGS. 2A and 2B) may be fabricated on an abutment mount 60 configured for mounting to the implant analog 20 on the dental model 10 during manufacture and test-fitting, and for subsequently mounting to the actual dental implant in the patient's mouth for final placement. The prosthesis is attached by insertion of an abutment screw 70 through a stepped internal bore of the abutment mount 60, and into the implant analog 20 of the model 10 (or ultimately into the actual implant in the patient's mouth). The abutment mount 60 preferably includes a hexagonal lower engagement portion 62 configured for closely fitting installation within the hexagonal recess 24 of the implant analog 20 of the model 10 (and correspondingly into a likewise configured hexagonal recess in the actual dental implant in the patient's mouth). The abutment mount preferably also comprises a lower abutment surface for butt-joint contact with the annular abutment contact surface 28 of the implant analog 20 (and correspondingly with the top face of the actual dental implant when placed in the patient's mouth). In example embodiments of the model 10 that incorporate a thread-retention portion or body, the abutment screw 70 is installed with its external male threads in mating threaded engagement with internal female threads of the thread-retention portion or body. For example, as shown in FIG. 2B and FIG. 3, the abutment screw 70 is installed through the abutment mount 60 and into threaded engagement with the metal nut 40 positioned in the lower recess 50 of the model 10. The provision of a thread-retention portion or body such as the nut 40 allows tighter engagement of the abutment screw during placement on the implant analog 20 of the model 10, to more closely match actual placement conditions of the prosthesis onto the actual dental implant in the patient's mouth, and eliminates or substantially reduces the incidence of stripping threads or otherwise damaging the model and/or implant analog during manufacture and fitting of the prosthesis using the model. After testing and fitting the prosthesis using the model 10, the practitioner fits and affixes the prosthesis to the actual dental implant in the patient's mouth.

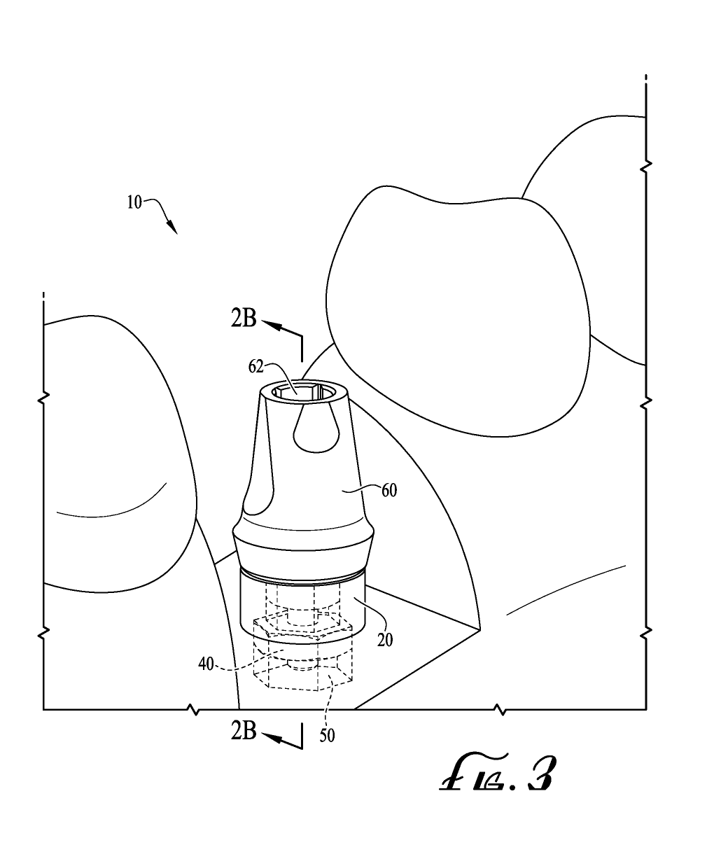

FIG. 4 shows an alternative mode of modeling and attachment of a dental prosthesis using a dental model 110 incorporating an implant analog 120. The prosthesis is attached to the model 110 in this embodiment by mounting the abutment mount 160 of the prosthesis onto the analog 120, and installing the abutment screw 170 from below, through the lower recess 150 in the underside of the model, and tightening the abutment screw into engagement with the internal threads of the abutment mount. The thread retention portion may optionally be omitted when utilizing this attachment mode, as the threads of the abutment mount typically provide adequate thread-holding capacity.

FIG. 5 shows an implant analog 220 for dental modeling, according to another example embodiment. The distal face of the external geometry 222 of the analog 220 defines a polygonal engagement recess 224 for receiving engagement of a cooperative polygonal engagement portion 262 of a dental prosthesis abutment mount. As shown in the depicted embodiment, a generally triangular or trilobular engagement recess 224 can be functionally analogous to a hexagonal recess, with its three side surfaces operatively engaging every other (alternating) side of the six side surfaces of a hexagonal male engagement profile of a corresponding dental prosthesis abutment mount. The provision of a triangular recess may be easier to manufacture by milling, 3D printing, or otherwise; and/or may provide better centering or other functional benefit, relative to a hexagonal recess. In further alternate embodiments, a triangular, square, hexagonal or other polygonal or polylobular or otherwise configured female recess configuration may be provided, compatible with a matching or non-matching triangular, square, hexagonal or other polygonal or polylobular or otherwise configured male engagement profile configuration.

The invention further comprises a workflow process or method, which in example embodiments may include steps selected from:
Developing a treatment plan incorporating use of one or more dental implants to support a dental prosthesis in a human or animal patient's mouth.
Generating a digital model of the patient's dentition at least in the area surrounding the intended site of the dental implant.
Directly fabricating a physical model of the patient's dentition at least in the area surrounding the intended site of the dental implant from the digital model; the physical model including at least one implant analog modeling an actual dental implant in the patient's mouth, and modeled dentition modeling the patient's actual dentition surrounding the implant site.
Preparing a dental prosthesis using the physical model to test the fit and placement of the dental prosthesis in connection with the implant analog, and relative to the surrounding modeled dentition, and adjusting or modifying the prosthesis as necessary to produce the desired fit.
Fitting the dental prosthesis to the patient, making final adjustments or modifications as needed, and affixing the prosthesis to the dental implant in the patient's mouth.

While the invention has been described with reference to example embodiments, it will be understood by those skilled in the art that a variety of modifications, additions and deletions are within the scope of the invention, as defined by the following claims.

What is claimed is:

1. A dental model comprising an implant analog and modeled dentition surrounding the implant analog, wherein the implant analog models an actual dental implant in the mouth of a patient and the modeled dentition models actual dentition surrounding the actual dental implant in the mouth of the patient, and wherein the implant analog and modeled dentition comprise an integrally formed monolithic body.

2. The dental model of claim 1, wherein the implant analog comprises a modeled polygonal recess configured to be functionally analogous to a polygonal recess in the actual dental implant.

3. The dental model of claim 2, wherein at least one of the polygonal recess in the actual dental implant and the functionally analogous modeled polygonal recess of the implant analog comprise a hexagonal recess.

4. The dental model of claim 1, further comprising a thread-retention portion comprising a thread-retention material having a greater thread-holding capacity than a base material from which the integrally formed monolithic body is formed.

5. The dental model of claim 4, wherein the thread-retention portion comprises an insert positioned in operative alignment with the implant analog.

6. The dental model of claim 5, wherein the insert comprises a hexagonal metal nut with a threaded bore.

7. The dental model of claim 6, wherein the metal nut is retained within a hexagonal bore coaxially aligned with the implant analog.

8. The dental model of claim 1, wherein the dental model is fabricated directly from a digital model generated by scanning the actual dental implant and the actual dentition in the mouth of the patient.

9. The dental model of claim 8, wherein the integrally formed monolithic body is fabricated by 3-D printing based on the digital model.

10. The dental model of claim 8, wherein the integrally formed monolithic body is fabricated by computer-aided milling based on the digital model.

11. A system for dental modeling and delivery of a dental prosthesis to a patient, the system comprising:
a dental implant for implantation in the mouth of the patient;
a dental prosthesis comprising an abutment mount configured for cooperative engagement with the dental implant;
an abutment screw configured for engagement through the abutment mount and into engagement with the dental implant to retain the dental prosthesis in place on the dental implant; and
a dental model comprising an implant analog and modeled dentition surrounding the implant analog, wherein the implant analog models the dental implant and the modeled dentition models actual dentition in the mouth of the patient, and wherein the implant analog and modeled dentition comprise an integrally formed monolithic body.

12. The system of claim 11, wherein the dental implant comprises a first polygonal recess, and wherein the implant analog comprises a second polygonal recess functionally analogous to the first hexagonal recess.

13. The system of claim 12, wherein at least one of the first and second polygonal recesses comprise a hexagonal recess.

14. The system of claim 11, further comprising a thread-retention portion comprising a thread-retention material having a greater thread-holding capacity than a base material from which the integrally formed monolithic body is formed.

15. The system of claim 14, wherein the thread-retention portion comprises an insert positioned in operative alignment with the implant analog.

16. The system of claim 15, wherein the insert comprises a hexagonal metal nut with a threaded bore.

17. The system of claim 16, wherein the metal nut is retained within a hexagonal bore coaxially aligned with the implant analog.

18. The system of claim 11, wherein the dental model is fabricated directly from a digital model generated by scanning the dental implant and the actual dentition in the mouth of the patient.

19. The system of claim 18, wherein the integrally formed monolithic body is fabricated by 3-D printing based on the digital model.

20. The system of claim 18, wherein the integrally formed monolithic body is fabricated by computer-aided milling based on the digital model.

21. The system of claim 11, wherein the dental model comprises a lower recess opposite the implant analog, and wherein the implant analog defines an internal recess coaxially aligned with and extending into communication with the lower recess, and wherein the abutment screw can be installed from below the dental model through the lower recess, through the internal recess of the implant analog, and into threaded engagement with internal threads of the abutment mount.

22. A method of dental modeling for installation of a dental prosthesis in a patient's mouth, the method comprising:
providing a dental implant for placement at an implant site in the patient's mouth adjacent to surrounding dentition;
generating a digital dental model by scanning the implant site and the surrounding dentition, wherein the digital model comprises data corresponding to at least one characteristic of the dental implant;
fabricating a physical dental model based on the digital dental model, the physical dental model comprising at least one implant analog modeling the dental implant and modeled dentition modeling the surrounding dentition, and wherein the implant analog and modeled dentition comprise an integrally formed monolithic body;
preparing a dental prosthesis using the physical dental model; and
affixing the dental prosthesis to the dental implant in the patient's mouth.

23. The method of claim 22, wherein the integrally formed monolithic body of the physical dental model is fabricated by 3-D printing based on the digital dental model.

24. The method of claim 22, wherein the integrally formed monolithic body of the physical dental model is fabricated by computer-aided milling based on the digital dental model.

25. The method of claim 22, wherein the physical dental model further comprises a thread-retention portion comprising a thread-retention material having a greater thread-holding capacity than a base material from which the integrally formed monolithic body of the physical dental model is formed, and wherein the method further comprises affixing the dental prosthesis to the implant analog of the physical dental model by engagement of an abutment screw through the dental prosthesis and through the implant analog and into threaded engagement with the thread-retention portion.

26. The method of claim 22, wherein the step of preparing the dental prosthesis using the physical dental model comprises mounting the dental prosthesis to the physical dental model by engagement of a threaded abutment screw with the dental prosthesis and the physical dental model.

27. The method of claim 26, wherein the threaded abutment screw is engaged downwardly from above the physical dental model through a bore extending through the dental prosthesis, through an internal recess of the implant analog, and into engagement with a thread-retention portion of the physical dental model.

28. The method of claim 26, wherein the threaded abutment screw is engaged upwardly from below the physical dental model through a lower recess opposite the implant analog, through an internal recess of the implant analog, and into threaded engagement with internal threads of the dental prosthesis.
